(19) United States
(12) Patent Application Publication
(10) Pub. No.: US 2018/0041863 A1
(43) Pub. Date: Feb. 8, 2018

(54) METHOD AND APPARATUS FOR RESOURCE SELECTION USING SENSING OPERATION FOR VEHICLE-TO-PEDESTRIAN COMMUNICATION

(71) Applicant: ZTE (USA) Inc., Austin, TX (US)

(72) Inventor: Carolyn Taylor, Homewood, IL (US)

(21) Appl. No.: 15/669,416

(22) Filed: Aug. 4, 2017

Related U.S. Application Data
(60) Provisional application No. 62/371,270, filed on Aug. 5, 2016.

(51) Int. Cl. H04W 4/02; H04L 29/08; G01S 5/00; G08G 1/16

(52) U.S. Cl. CPC H04W 4/02; G08G 1/166; G08G 1/161; H04L 67/12; G01S 5/0072

(57) ABSTRACT

Method and apparatus for pedestrian user equipment (P-UE) to obtain radio resources for wireless transmission directly to other proximate UEs, including sensing available communication channel resources from a pool of channel resources, selecting specific resources from the available channel resources to use for data transmission; and transmitting data using the selected channel resources.

### BRIEF DESCRIPTION OF DRAWINGS

The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims. In the drawings:

FIG. 1 illustrates that sidelink (SL) communications occur directly between vehicle user equipment (V-UE) and pedestrian user equipment (P-UE), without the involvement of an e-UTRAN eNodeB.

FIG. 2 shows an architectural framework for LTE communications, updated with reference points to support D2D.

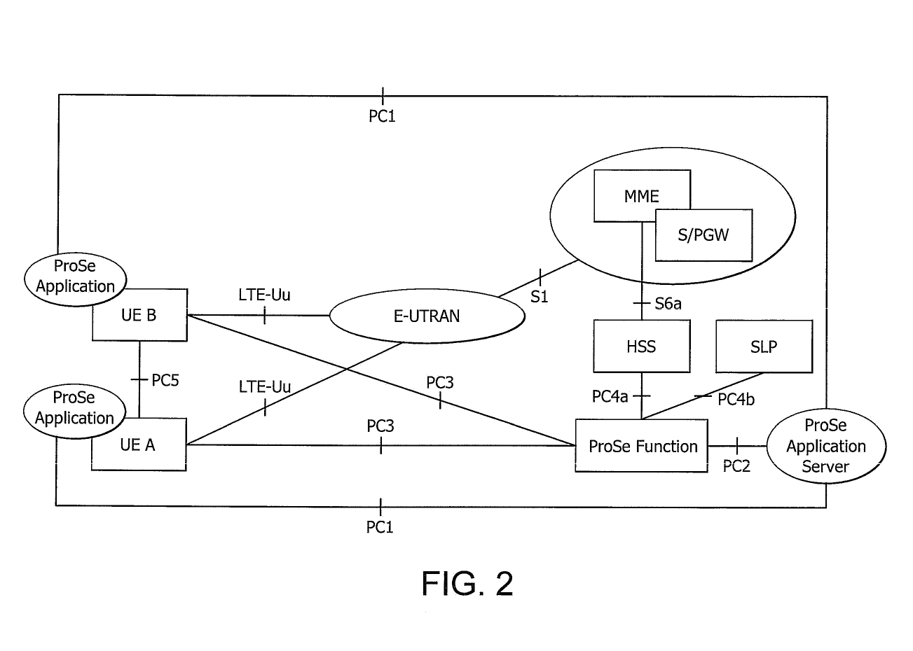

FIG. 3 illlustrates a sensing operation of limited duration by a P-UE.

### BACKGROUND AND DETAILED DESCRIPTION

It is to be understood that the figures and descriptions provided herein may have been simplified to illustrate aspects that are relevant for a clear understanding of the herein disclosed processes, machines, manufactures, and/or compositions of matter, while eliminating for the purpose of clarity other aspects that may be found in typical devices, systems, and methods. Those of ordinary skill in the pertinent art may recognize that other elements and/or steps may be desirable and/or necessary to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art. Furthermore, the following descriptions are provided as teaching examples and should not be construed to limit the scope of the invention. Rather, the scope of the invention is defined by the claims. Although specific details may be disclosed, embodiments may be modified by changing, supplementing, or eliminating many of these details.

Pedestrians generally walk or run along the side of a road if there is no sidewalk, and cross streets and intersections at crosswalks. Because these activities occur within or adjacent to roads where vehicles of all types drive, pedestrians must maintain an awareness of proximate traffic to avoid getting hit by moving vehicles. This is particularly true in urban areas where foot traffic and vehicular traffic can both be dense, and people may be inattentive and not use due care, for example if they are in a hurry. A large portion of pedestrians carry cell phones or the like (hereinafter, pedestrian user equipment, or P-UE), which they commonly use to communicate with remote parties, listen to music, and the like while they are on foot. Vehicles also commonly use built-in wireless communications components including cellular components (hereinafter, vehicle user equipment, or V-UE) for purposes such as obtaining directions to a destination, obtaining information of traffic conditions along an intended route, listening to entertainment, and the like.

The increasing prevalence and continuing development of cellular communications has given rise to opportunities to improve vehicular and pedestrian safety on the roads. To do so, new capabilities are needed in P-UEs and V-UEs so that they can signal each other, provide situational awareness to their users, detect potential hazards, and alert the user when a hazard is detected. Cellular standards are developed by the 3rd Generation Partnership Project (3GPP), a collaboration between groups of telecommunications associations. The relevant 3GPP working groups are currently engaged in developing such capabilities for inclusion in cellular communication standards. Considerations that must be taken into account by relevant workgroups include costs associated with necessary changes to UEs, changes to wireless system operator equipment such as eNodeB resources, radio spectrum allocation and availability, the management of power consumed during operation, ongoing compatibility with pre-existing UEs that do not conform to the new standards, the density and capabilities of the existing communications infrastructure, wireless traffic congestion and resource management, to name a few.

To use UE services to avoid collisions with vehicles and otherwise enhance road safety, it is of fundamental importance that the UEs be kept aware of their surroundings and the proximity of UE-bearing parties to each other. For example, a P-UE may perform some sort of intermittent sensing operation to maintain an awareness of the distance and velocity (speed and direction of movement) of nearby vehicles. To conserve battery power, it would be advantageous to perform the sensing as seldom as possible while still maintaining adequate situational awareness. When there are vehicles in motion nearby and they're all moving slowly, it may be sufficient to perform the sensing at lengthy intervals. However, the duration of the intervals must be adapted to the distance and velocity of proximate vehicles in proximity to the P-UE. The more quickly a vehicle closes the distance to the P-UE, the more frequently the P-UE's sensing must be performed to maintain a consistent situational awareness, and the more quickly and precisely the P-UE needs to interpret the sensed information to determine proximity to a potentially hazardous vehicle. In this context, the P-UE can be a signal transmitter, a signal receiver, or both, depending on the task at hand.

Communication between UEs and eNodeBs takes place over uplink (UL) and downlink (DL) channels. Communication can also take place directly between UEs with minimal or no involvement of an eNodeB. This is called device-to-device (D2D) communication and takes place over sidelinks (SL). Parameters that define a pool of resources for use in D2D are broadcast in a system information block (SIB) by the eNodeB. UEs that are not within range of an eNodeB and so cannot acquire the SIB can still communicate D2D using pre-configured values stored internally in the UEs. D2D uses two physical channels, a physical sidelink control channel (PSCCH) for control information, and a physical sidelink shared channel (PSSCH) for data. 1232″

The PSCCH is used by the D2D transmitting UE to make other UEs aware of the next data transmission that will occur on the PSSCH. To do so, the transmitting UE sends over the PSCCH a sidelink control information (SCI) block. Devices using D2D blindly scan the whole resource pool to determine if the needed resources are available. Two modes of resource allocation have been defined. Mode 1, so-called “scheduled resource allocation”, uses resources defined by an eNodeB in the SIB. Mode 2, called “UE autonomous resource selection” is out of range of the eNodeB and cannot acquire the SIB, so the resources are defined by the pre-configured or default values stored internally in the UEs.

Services having to do with determining and using information of the proximity of UEs to each other are called proximity services. In general proximity services require two main direct communication mechanisms, discovery and direct communication. The discovery mechanism is used to determine the proximity of a UE to other UEs without network assistance. The direct communication mechanism is used for data transmission between UEs. Work items pertaining to these are initiated at 3GPP in working groups, and generally involve service and system aspects (SA working groups) and radio access network definitions (RAN working groups).

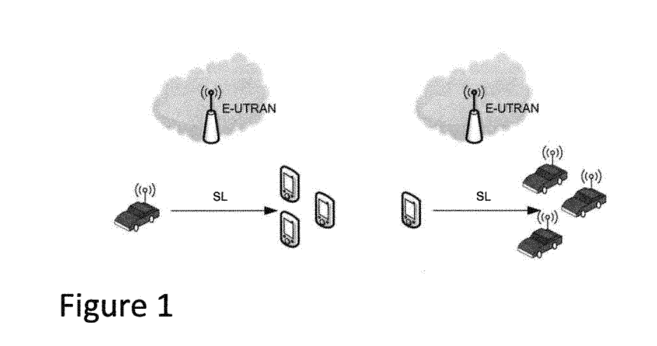

Proximity services using D2D were first supported in LTE Release 12, and development is ongoing, with new capabilities introduced with each new standards release. The 3GPP reference architecture was updated to support proximity services as shown in FIG. 1. Two primary new elements support D2D communications in general, and proximity services in particular. One is the PC5 interface, the direct interface between two devices communicating D2D. The other is the proximity service function, which includes providing to the UE the parameters needed for resource discovery and communication, and for allocating and storing the application identifiers and filters for the discovery services, among other things. In addition, the proximity services function is responsible for the PC3 interface between the devices and the proximity services function itself.

The PC5 interface re-uses the frequency allocation of whatever the duplex mode is, either frequency division duplex (FDD) or time division duplex (TDD). To minimize the hardware impact on the user equipment (UE), D2D transmission occurs primarily in the uplink band in case of FDD. Similarly, the PC5 interface uses sub-frames otherwise reserved for uplink transmission in TDD. The D2D communication channels are configured to minimize their impact on transmissions on uplink channels.

A relevant work item description (WID) for long term evolution (LTE)—based wireless vehicle (V2X) services discloses features needed to support vehicle to pedestrian (V2P) services. Some features require direct signaling between UEs (device-to-device, D2D) through an interface between devices called the PC5 interface. Notably, there is no dedicated frequency band for D2D communications, and devices communicating in direct mode must share resources with the uplink of devices attached to the network. One of the features disclosed in the WID pertains to the random selection of resources for P-UEs from a PC5 resource pool potentially shared with V-UE transmissions. The WID calls for further study regarding sensing operations performed by P-UEs for limited time periods. The WID is 3GPP document RP-161298, a work item description (WID) entitled “LTE-based V2X Services” by LG Electronics et al., the entirety of which is hereby incorporated as if fully set forth herein.

The inventors have observed that issues pertaining to the sensing operation for P-UEs include increases in the cost of the P-UEs; efficient energy usage and power consumption; and packet reception ratio (PRR) performance characteristics. With regard to the cost increase of the P-UEs, there is an increase in cost associated with resource selection for sensing operations for P-UEs because D2D signaling needs to be received by the P-UEs. This aspect is disclosed in the 3GPP document R1-164455 entitled “PC5 for V2P”, by Qualcomm Incorporated, the entirety of which is hereby incorporated by reference as if fully set forth herein. The most serious issue however is efficiency of power consumption. This is because the resources selected for the P-UE sensing operation can have a large impact on power consumption. However, one of the objectives in the WID of LTE-based V2X services is to modify the PC5 interface parameters in a way that would enhance efficiency of power consumption.

With regard to packet reception ratio (PRR) performance characteristics, the PRR for a P-UE has been determined to fair well when the P-UE performs channel sensing for a limited duration. This is because channel sensing uses a collision avoidance method. Collision avoidance methods in general aim to avoid resource contention by attempting to avoid simultaneous access to the same resources by more than one UE. Collision avoidance can be used when sensing resource availability for P-UEs because it is based on the principle that P-UEs must listen to a channel for a time before using it to transmit data, to determine whether another UE is already transmitting on the channel. A P-UE can start transmitting on the channel only if it appears to be idle. If the channel is not idle, the transmission is deferred. Collision avoidance improves PRR performance by preventing multiple P-UEs from transmitting on the same channel at the same time because the likelihood of transmission collision is reduced. Performing channel sensing for brief time periods by a P-UE to conserve energy has been observed to have relatively minor impact on the UE's PRR performance compared to continuous sensing, while the energy conserving effect on battery life is significant.

Furthermore, D2D can use both licensed and unlicensed spectrum in combination to increase D2D throughput. And, D2D communication does not involve an eNodeB, so eNodeb capacity can provide services to additional UEs. In addition, sensing operations for P-UEs can exclude examining resources known to be occupied by other UEs.

A recent 3GPP regular meeting discussed aspects of PCS-based V2P/P2V. Observations discussed included, in D2D communication between a P-UE and a V-UE, the P-UE TX to V-UE RX scenario is more battery efficient for the P-UE than the V-UE TX to P-UE RX scenario. This observation was based on evaluations from a limited number of companies. The P-UE power consumption analysis result is presented in the 3GPP document TR 36.885 V2.0.0 (2016-06) entitled “3rd Generation Partnership Project; Technical Specification Group Radio Access Network; Study on LTE-based V2X Services”, the entirety of which is hereby incorporated by reference as if fully set forth herein. For the purpose of P-UE TX to reduce the power consumption and UE complexity, random resource selection by P-UEs was determined to be beneficial. Sensing operation for a limited time period was recognized as a possible beneficial approach requiring further study. In particular, it had been observed that a P-UE sensing operations of limited duration can improve the PRR performance. It was further noted that, even though there is a cost increase to P-UEs when using sensing operation (because D2D signals needs to be received by P-UEs), D2D can include both licensed and unlicensed spectrum. Combining unlicensed spectrum with LTE was determined to increase the traffic-bearing capacity of the eNB service area in which directly communicating devices are located, and may mitigate an eNB overload condition.

It has been further recognized, however, that a sensing operation of P-UEs may be configured to exclude resources known to be occupied or soon to be occupied by other UEs, thereby improving the power efficiency of sensing operations. Moreover, limiting the duration of sensing operations by P-UEs to locate available transmission resources has also been recognized as effective to provide good sensing operation results, thereby even further improving the power efficiency of sensing operations by P-UEs. Using these approaches, the power efficiency of a P-UE searching for available resources to allocate for transmission is improved while maintaining PRR performance.

A trade-off was also observed between the cost increase of P-UEs and the efficiency of resource allocation and PRR performance. It has been determined to be beneficial to increase the cost of P-UEs in order to more efficiently allocate resources while maintaining PRR performance, in large part because this approach has the minimum adverse effect on how long a P-UE battery charge lasts.

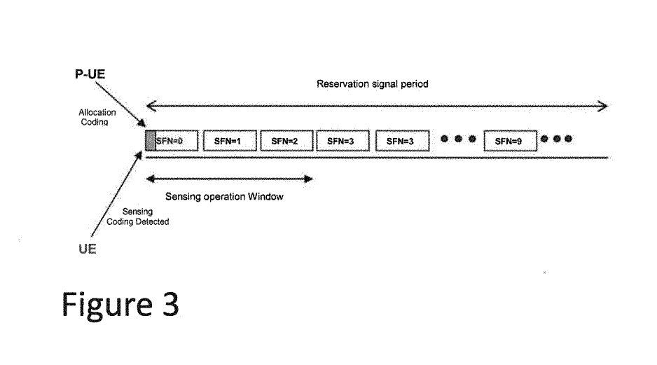

One aspect of limited duration sensing operations that may be beneficial is the use of a resource reservation signal, for example, a type of allocation coding. That is, the P-UE may transmit a resource reservation signal for channel reservation purposes. The information that the P-UE transmits may not need to contain any essential information for the receiver UE to decode during the reservation time period. The P-UEs may transmit a resource reservation signal to reserve resources for channels on which availability of their associated subframe is coded. An example of a sensing operation of limited duration for a P-UE is shown in FIG. 3.

Moreover, in order to reduce the power consumption and UE complexity due to the P-UE TX, it was observed that random resource selection and limited duration sensing operations would be beneficial. This combination is particularly beneficial when the random resource selection by a UE excludes resources that are or will be occupied by other UEs, and applying the random resource selection only to the remaining resources.

Although the invention has been described and illustrated in exemplary forms with a certain degree of particularity, it is noted that the description and illustrations have been made by way of example only. Numerous changes in the details of construction, combination, and arrangement of parts and steps may be made. Accordingly, such changes are intended to be included within the scope of the disclosure, the protected scope of which is defined by the claims. It should be appreciated that, while selected embodiments have been described herein for illustration purposes, various modifications may be made without deviating from the scope of the invention. Accordingly, the invention is not limited except as by the appended claims and the elements explicitly recited therein.

1.-18. (canceled)

19. A method for a pedestrian user equipment (P-UE) to obtain radio resources for a wireless transmission directly to other proximate UEs, comprising:
sensing, by the P-UE, for available communication channel resources from a pool of channel resources defined by one or more parameters;
selecting specific resources from the available channel resources to use for data transmission; and
transmitting data using the selected channel resources.

20. The method of claim 19, wherein the sensing excludes channel resources that are known by the P-UE to be in use by one or more other UEs.

21. The method of claim 19, wherein the sensing excludes channel resources that have been reserved for use by one or more other UEs.

22. The method of claim 19, wherein the sensing occurs over a limited time period of predetermined duration.

23. The method of claim 22, wherein the sensing occurs intermittently in accordance with a predetermined regular schedule.

24. The method of claim 22, wherein the sensing occurs randomly intermittently, not in accordance with a regular schedule.

25. The method of claim 22, wherein the sensing occurs sufficiently frequently to have an adverse impact on the receiver UEs' packet reception ratio (PRR) that is less than a predetermined threshold.

26. The method of claim 19, wherein the P-UE is located in the service area of an eNodeB, and the channel defining parameters are obtained from the eNodeB.

27. The method of claim 19, wherein the P-UE is not located in the service area of an eNodeB, and the channel defining parameters are obtained from a preconfigured data storage of the P-UE.

28. Apparatus for obtaining radio resources by a pedestrian user equipment (P-UE) for a wireless transmission directly to other proximate UEs, comprising:
the P-UE, including:
at least one sensor for sensing available communication channel resources from a pool of channel resources defined by one or more parameters;
a circuit for selecting specific resources from the available channel resources to use for data transmission; and
a transmitter for transmitting data using the selected channel resources.

29. The apparatus of claim 28, wherein the P-UE further includes a circuit that prevents sensing channel resources known by the P-UE to be in use by one or more other UEs.

30. The apparatus of claim 28, wherein the P-UE further includes a circuit that prevents sensing channel resources that have been reserved for use by one or more other UEs.

31. The apparatus of claim 28, wherein the P-UE further includes a timer and a circuit that causes the sensing to occur over a limited time period of predetermined duration.

32. The apparatus of claim 31, wherein the P-UE further includes a timer and a circuit that causes the sensing to occur intermittently in accordance with a predetermined regular schedule.

33. The apparatus of claim 31, wherein the P-UE further includes a circuit that causes the sensing to occur randomly intermittently, not in accordance with a regular schedule.

34. The apparatus of claim 32, wherein the P-UE further includes a circuit that causes the sensing occurs sufficiently frequently to have an adverse impact on the receiver UEs' packet reception ratio (PRR) that is less than a predetermined threshold.

35. The apparatus of claim 28, wherein the P-UE is located in the service area of an eNodeB, and the channel defining parameters are obtained from the eNodeB.

36. The apparatus of claim 28, wherein the P-UE is not located in the service area of an eNodeB, and the channel defining parameters are obtained from a preconfigured data storage of the P-UE.

37. The method of claim 23, wherein the sensing occurs sufficiently frequently to have an adverse impact on the receiver UEs' packet reception ratio (PRR) that is less than a predetermined threshold.

38. The apparatus of claim 33, wherein the P-UE further includes a circuit that causes the sensing occurs sufficiently frequently to have an adverse impact on the receiver UEs' packet reception ratio (PRR) that is less than a predetermined threshold.
